(19) United States
(12) Patent Application Publication
(10) Pub. No.: US 2011/0214632 A1
(43) Pub. Date: Sep. 8, 2011

(54) HYDRO-MECHANICAL VARIABLE VALVE ACTUATION

(76) Inventors: Manousos Pattakos, Nikea Piraeus (GR); John Pattakos, Nikea Piraeus (GR); Emmanouel Pattakos, Nikea Piraeus (GR)

(21) Appl. No.: 12/719,010

(22) Filed: Mar. 8, 2010

(51) Int. Cl. F01L 9/02; F16K 31/02

(52) U.S. Cl. 123/90.12; 251/129.03

(57) ABSTRACT

A hydro-mechanical variable valve actuation system capable to operate according the “ingoing air control” mode the multiair system of Fiat operates and according the “outgoing air control” mode wherein the load is controlled by the quantity of air that the intake valves allow to escape from the cylinder.

A different long-duration cam lobe and a reprogramming of the digital controller is all it takes in order to upgrade the existing multiair system of Fiat.

This invention relates to an improved hydro-mechanical variable valve actuation system.

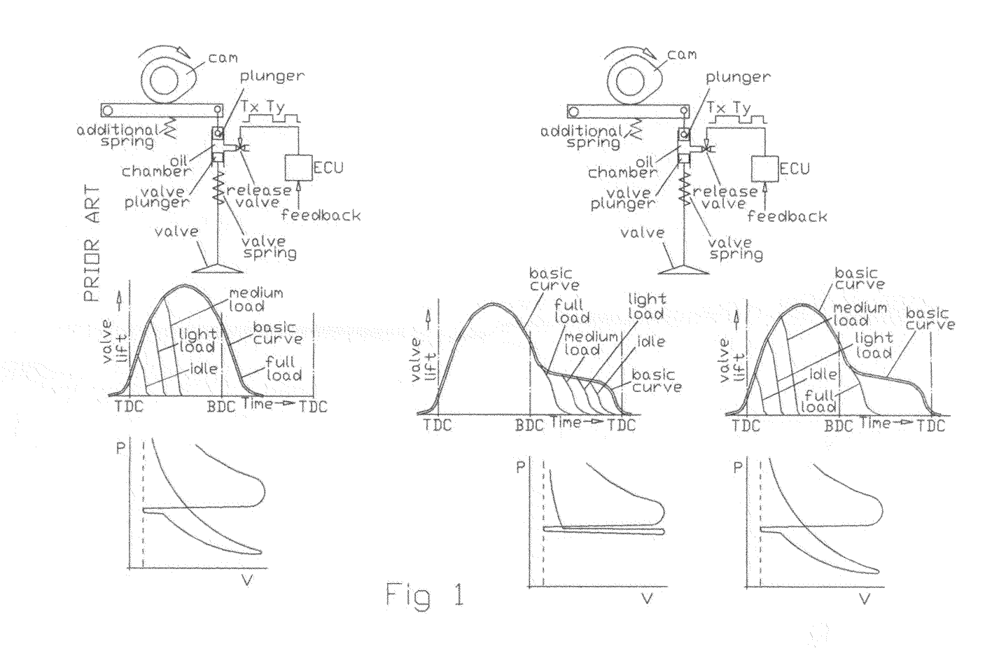

FIG. 1 shows diagrammatically the present mechanism in comparison to the prior art, at left.

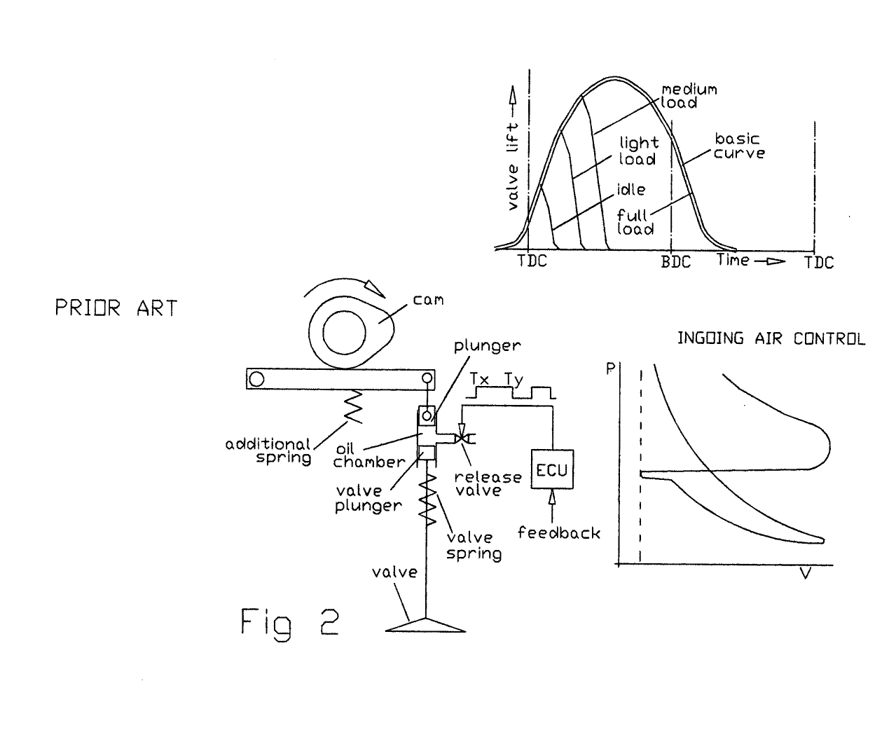

FIG. 2 shows the prior art.

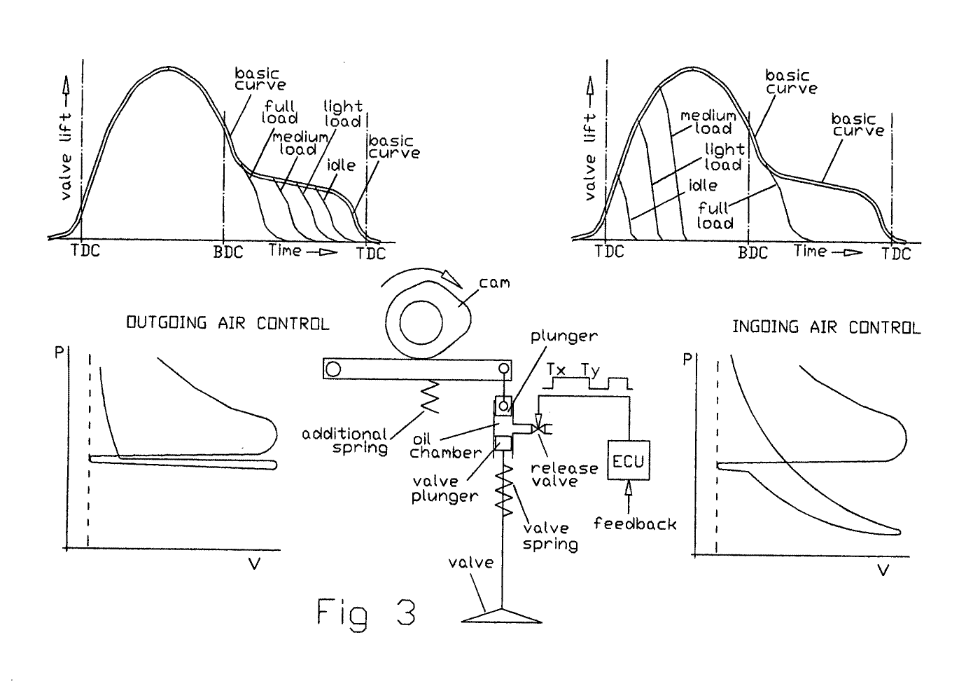

FIG. 3 shows the mechanism and the additional modes it can operate. It also shows the P-V diagram for the operation according the “ingoing air control” mode, and according the “outgoing air control” mode.

In FIGS. 1 to 3 the valve lift dictated by the camshaft is shown by double line.

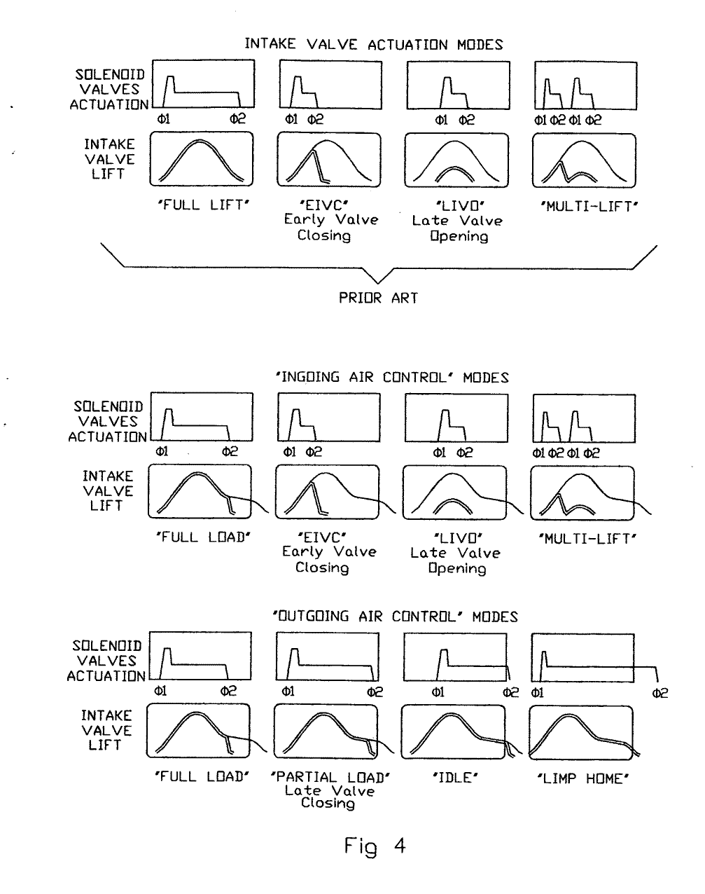

FIG. 4 shows the available modes of operation; at top are the available modes of the prior art.

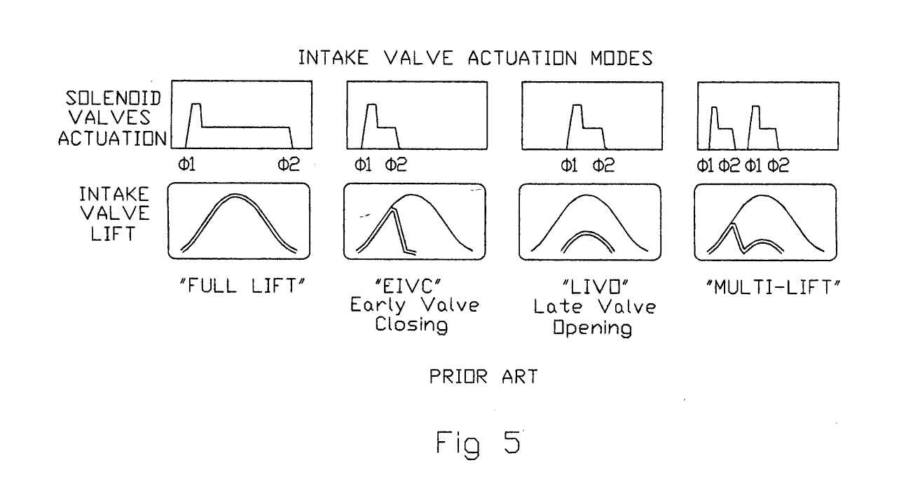

FIG. 5 shows the available modes of the prior art.

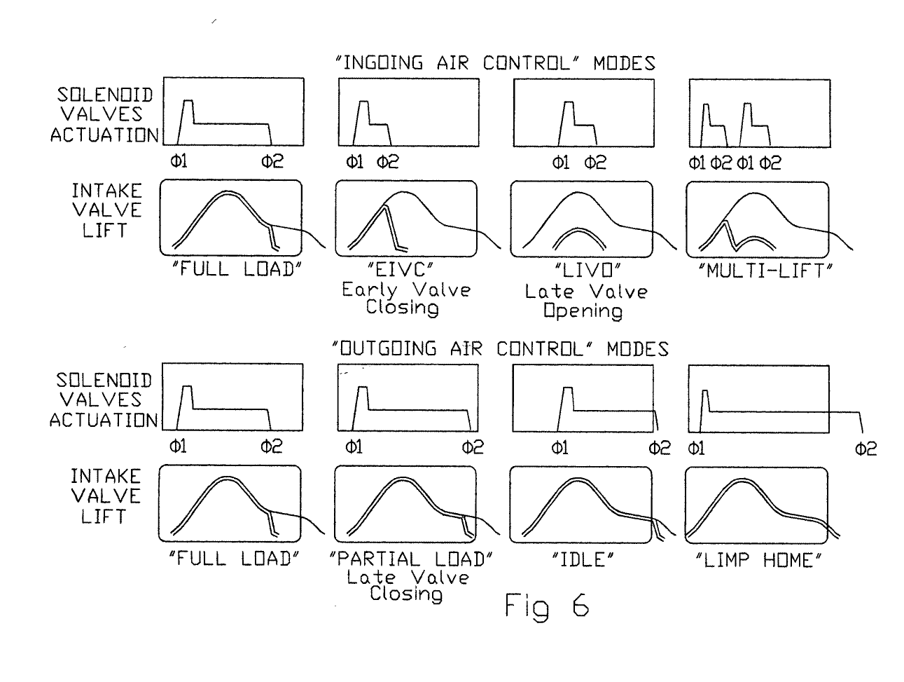

FIG. 6 shows the available modes of the present invention running according the “ingoing air control” mode and running according the “outgoing air control” mode, at bottom.

In FIGS. 4 to 6 the actual valve lift pattern is shown by double line.

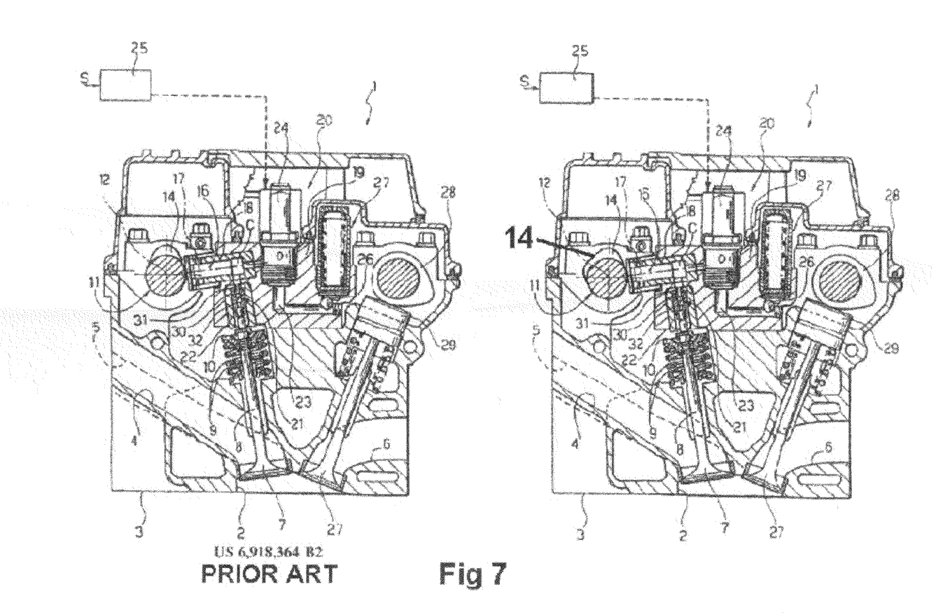

FIG. 7 shows the modification necessary to upgrade the state of the art hydro-mechanical VVA: the intake cam (14) is modified to provide the necessary longer duration, while the digital controller is reprogrammed.

The closest prior art is the multiair (or UniAir) system of Fiat, U.S. Pat. No. 6,918,364 etc, a lost motion hydro-mechanical VVA currently in mass production, wherein a cam, FIG. 2, opens the valve indirectly by means of oil interposed “in series” between the valve and the cam: the cam by a plunger displaces the oil, and the oil displaces the valve. A release valve, for instance a solenoid valve, opens the right moment to allow the oil to escape and the valve to close, reducing either the duration or the duration and the lift, FIG. 2 top right. The load-control, or throttling, is realized by the “ingoing air control”: the intake valves prevent more air from entering the cylinder. At full load the intake valves follow the motion dictated by the cam.

The main advantages claimed by the multiair system are the reduction of the pumping loss and the variable modes the system can operate in order to optimize the operation of the engine. The present system, FIG. 3, achieves further reduction of the pumping loss and doubles the available modes of operation, keeping the cost and complication unchanged.

In the prior art the intake valves of a cylinder close at a crankshaft angle to prevent more air from entering the cylinder, so that the load is controlled by controlling the “ingoing air”, so that the engine operates according the “ingoing air control” mode. As the piston moves towards BDC, the trapped air both expands and comes into contact with the walls. The expansion lowers the temperature of the air that increases the convection of heat from the walls to the air. The temperature of the air increases causing the respective pressure increase, i.e. the pressure at a crankshaft angle after BDC is higher than the pressure at an equal crankshaft angle before BDC, because in the meantime the walls warm the relatively colder air. The wider the crankshaft angle before and after BDC, the more the difference. A further temperature increase is caused by the pressure increase owing to the piston motion: the piston delivers more mechanical energy to the air because of the higher pressure, thereby causing even higher temperature.

In the present invention, the same intake valves stay open until a crankshaft angle before TDC. Air enters into the cylinder as the piston moves towards BDC with the intake valves open, then a part of the air exits from the cylinder as the piston moves towards TDC with the intake valves still open, until the crankshaft angle where the intake valves close, so that the engine load is controlled by controlling the “outgoing air”, so that the engine operates according the “outgoing air control” mode.

In this “outgoing air control” mode there is neither expansion of the trapped air before BDC, nor compression of trapped air after BDC and before the intake valves closing. The intake valves close with the pressure and temperature of the trapped air near to those of the intake manifold, and with the minimum mechanical energy spent for this intake stroke. I.e. replacing the “ingoing air control” mode of the closest prior art by the “outgoing air control” mode, the pumping energy reduces and the temperature of the air lowers. The swirl and turbulence resulting from the late closing of the intake valves of the “outgoing air control” mode can sustain until the combustion, whereas the swirl and turbulence resulting from the early closing of the intake valves of the “ingoing air control” mode of the prior art, have more time to die out before the combustion.

In this invention, the engine can operate either in the closest prior art mode, FIG. 3 right and FIG. 6 top, i.e. the “ingoing air control” mode wherein the lighter the load the greater the part of the air that the intake valves stop from entering the cylinder, or according the “outgoing control” mode, FIG. 3 left and FIG. 6 bottom, disclosed also in the U.S. Ser. No. 12/717,947 application, wherein the lighter the load the greater the part of the air that the intake valves allow to exit from the cylinder back into the intake manifold.

I.e. the present system can do everything the prior art does, and many more, without additional cost or complication.

In order to upgrade the existing multiair system of Fiat into the present system, what it takes is a reprogramming of the digital unit and a substantially different cam contour for the camshaft, as shown in FIG. 7. The existing camshaft can be machined to have a longer duration cam contour, for instance a duration of 420 crankshaft degrees in order to keep the intake valves open substantially after the middle stroke of the piston moving towards TDC. The intake valve lift dictated by the camshaft, shown by double line in FIGS. 1 to 3, can extend for several crankshaft degrees after the combustion dead center. The timing of the camshaft can be, for instance: the intake valves open 30 degrees before the TDC and close 420 crankshaft degrees later, i.e. 30 degrees after the combustion TDC. Combustion TDC is the TDC where the combustion occurs once per four strokes.

The digital control enables various modes of operation. It enables even the use of different modes for different cylinders, for instance it makes possible the operation with some cylinders running according the “ingoing air control” mode, with some others running according the “outgoing air control” mode and with the rest cylinders deactivated.

The proper design of the cam contour, for instance as in the FIGS. 1 to 4, allows a lower capacity solenoid valve to control the engine at higher revs, takes back a better part of the valve spring energy and alleviates the overloading of the hydraulic system, allows more aggressive valve lift profile for increased peak power, allows higher rev limit, etc.

An additional limb-home mode becomes available: the camshaft continues to close the intake valves a little before the combustion dead center, trapping into the cylinder a minimum quantity of charge and allowing the engine to keep on; by advancing the camshaft the engine load is controlled.

The “outgoing control” mode enables the over-expansion Atkinson/Miller cycle for economy and low emissions; combined with a Variable Compression Ratio system, like those disclosed in the patent applications U.S. Ser. No. 12/553,975, U.S. Ser. No. 12/546,714 and U.S. Ser. No. 12/404,355, the overall result is a variable capacity engine capable to provide better “overall fuel efficiency” and lower emissions as compared to the state-of-the-art hybrid cars. Applied on a Diesel engine, this system enhances the volumetric efficiency when it is advantageous, controls the actual compression ratio, enables the controllable exhaust gas recirculation, etc.

Although the invention has been described and illustrated in detail, the spirit and scope of the present invention are to be limited only by the terms of the appended claims.

1. A hydro-mechanical variable valve actuation system wherein a cam, rotating in synchronization to a crankshaft, activates indirectly an intake valve of a cylinder by means of oil trapped into an oil chamber and interposed between the cam and the valve; the cam displaces a plunger, the plunger displaces the oil and the oil displaces the intake valve; by opening a release valve, the oil escapes from the chamber and the intake valve restores, characterized in that the intake valve controls the load by controlling the quantity of the outgoing from the cylinder air.

2. A hydro-mechanical variable valve actuation system according claim 1 wherein the cam has a substantially long duration to keep the intake valve open substantially after the middle stroke of the piston moving towards the combustion top dead center.

3. A hydro-mechanical variable valve actuation system according claim 1 wherein the release valve is an electronically controlled solenoid valve.

4. A hydro-mechanical variable valve actuation system according claim 1 wherein for light load operation the release valve opens substantially after the bottom dead center.

5. A hydro-mechanical variable valve actuation system according claim 1 wherein the lighter the load the later the opening of the release valve after the bottom dead center.

6. A hydro-mechanical variable valve actuation system according claim 1 wherein the duration of the cam is longer than 270 crankshaft degrees.

7. A hydro-mechanical variable valve actuation system according claim 1 wherein the duration of the cam is longer than 300 crankshaft degrees.

8. A hydro-mechanical variable valve actuation system according claim 1 wherein the duration of the cam is longer than 350 crankshaft degrees.

9. A hydro-mechanical valve actuation system according claim 1 that controls the breathing of a variable compression ratio engine in order to provide a substantially variable capacity engine, thereby an engine capable to operate permanently at optimum thermal efficiency.

10. A hydro-mechanical variable valve actuation system according claim 1 wherein the late closing of the intake valve enables the over-expansion Atkinson/Miller cycle.
